(19) United States
(12) Patent Application Publication
(10) Pub. No.: US 2007/0289325 A1
(43) Pub. Date: Dec. 20, 2007

(54) DC TO AC AUXILIARY POWER UNIT

(76) Inventor: Tyler Stone, Whittier, CA (US)

Correspondence Address: Kenneth Green, 15245 Midcrest, Whittier, CA, 90604, US

(21) Appl. No.: 11/763,108

(22) Filed: Jun. 14, 2007

Related U.S. Application Data
(60) Provisional application No. 60/813,831, filed on Jun. 14, 2006.

(51) Int. Cl. F25B 27/00; H02K 7/18; F25B 49/00; B60H 1/32

(52) U.S. Cl. 62/323.1; 290/1 A; 62/132; 62/244

(57) ABSTRACT

An Auxiliary Power Unit (APU) includes a Direct Current (DC) alternator run off an auxiliary engine, and a power inverter to convert the DC power to AC power. The APU also runs an Air Conditioning compressor to provide cooling and heat from engine coolant in the auxiliary engine is used to provide heating. The APU is particularly useful for providing cooling, heating, and AC power for long haul trucks, and motor homes. An alternative embodiment for local trucks does not include the inverter.

The present application claims the benefit of U.S. Provisional Application Ser. No. 60/813,831, filed Jun. 14, 2006, which application is incorporated herein by reference.

### BACKGROUND OF THE INVENTION

The present invention relates to power generators and in particular to Auxiliary Power Units (APUs).

Trucks often carry cargo long distances and may be on the road for days at a time. The truck drivers virtually live in their trucks (or tractors), in many instances. Because of the extended periods which the drivers spend in the trucks, items such as air conditioning, heaters, refrigerators, etc. are used when the trucks are at rest. In the past, the truck's main engines were left running to provide power for these items. New federal laws require that this practice be discontinued, and an APU must be used in many cases to provide power to such items. Unfortunately, know APUs use Alternating Current (AC) alternators and must run at a single speed, due to AC frequency requirements, and thus provide only a single power level and do not efficiently provide electrical power at multiple voltages.

### BRIEF SUMMARY OF THE INVENTION

The present invention addresses the above and other needs by providing an Auxiliary Power Unit (APU) which includes a Direct Current (DC) alternator run off an auxiliary engine, and a power inverter to convert the DC power to Alternating Current (AC) power. The APU also runs an air conditioning compressor to provide cooling and heat from engine coolant in the auxiliary engine is used to provide heating. The APU is particularly useful for providing cooling, heating, and AC power for long haul trucks, and motor homes. An alternative embodiment for local trucks does not include the inverter.

In accordance with one aspect of the invention, there is provided a truck having a main engine for providing power to drive the truck and an Auxiliary Power Unit (APU). The APU provides power when the main engine is not running and includes an APU auxiliary engine, a DC alternator run by the APU auxiliary engine, and an inverter receiving DC power from the alternator and converting the DC power to AC power. The APU may also run an air conditioning compressor providing a flow of refrigerant to a condenser used to cool the interior of the tractor.

In accordance with another aspect of the invention, there is provided a APU system including an APU providing air conditioning, heating, and auxiliary power. The APU includes an APU housing, a liquid cooled diesel auxiliary engine residing inside the APU housing, an air conditioning compressor run by the auxiliary engine and residing inside the APU housing, a Direct Current (DC) alternator run by the auxiliary engine and generating DC electrical power and residing inside the APU housing, and a control unit for controlling the APU residing inside the APU housing. A radiator outside the APU housing is provided for cooling the auxiliary engine, an air conditioning condenser outside the APU housing is connected to the air conditioning compressor, and a fan provides a flow of air through the radiator and the air conditioning condenser. An inverter receives the DC electrical power from the alternator and converts the DC electrical power to Alternating Current (AC) power and an evaporator residing outside the APU housing and receives refrigerant from the APU and heated liquid coolant from the APU for cooling and heating. Electrical connections are also provided between the DC alternator and a main battery to recharge the battery.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a tractor and trailer with an Auxiliary Power Unit (APU).

FIG. 2 is a detailed view of elements of the APU.

FIG. 3 is a method for controlling humidity in a vehicle interior according to the present invention.

FIG. 4 is a method for automatic operation of the APU according to the Present invention.

FIG. 5 is a method for controlling APU auxiliary engine start-up according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

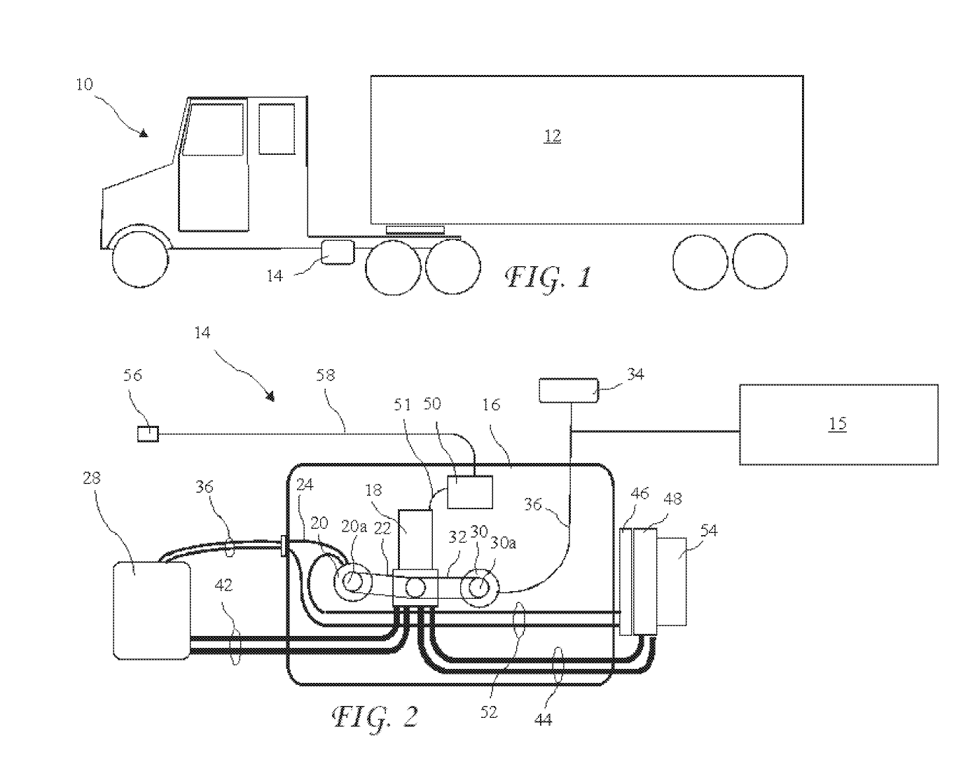

A tractor 10 and trailer 12 with an Auxiliary Power Unit (APU) 14 is shown in FIG. 1. During normal operation (i.e., driving) a main engine provides power to the tractor 10 for both motion and for accessories. The APU 14 provides power to the tractor when the main tractor engine is off, for example, when the tractor 10 and trailer 12 are parked for the night. The APU 14 may further power an air conditioning compressor 20 (see FIG. 2) to provide a flow of refrigerant to the tractor 10, and may provide heat to the tractor 10 in the form of heated auxiliary engine coolant. An APU 14 according to the present invention finds additional application in local trucks, motor homes, in temporary housing, and in other similar environments.

A detailed view of the APU 14 is shown in FIG. 2. The APU 14 includes a housing 16 which is preferably aluminum or fiberglass and more preferably aluminum. The functional elements of the APU 14 include an auxiliary engine 18, a DC alternator 30 connected to the auxiliary engine 18 by an alternator belt 32, the air conditioning compressor 20 connected to the auxiliary engine 18 by a compressor belt 22, and a control system 50 connected to the auxiliary engine 18 by wiring 51. Because the alternator 30 is a DC alternator, it may be operated at a range of RPM, and thus easily controlled to meet varying needs. A DC to AC inverter 34 preferably residing outside the housing 16, for example, in the tractor 10, and is connected to the alternator 32 by electrical cables 36 and provides AC power, for example, 120 volt 60 cycle AC power, for accessories and convenience items. A battery 15, preferably a main vehicle battery, is also connected to the alternator 32 by electrical cables 36. The inverter 34 may receive power from the DC alternator 30 when the auxiliary engine 18 is running, and from the battery 15 when the auxiliary engine 18 is not running. An alternative embodiment for local trucks does not include the inverter 34.

The compressor 20 is part of an air conditioning system configured to cool the inside of the tractor 10, a motorhome, and the like. A refrigerant line 24 runs from the compressor 20 to a connection point on the housing 16, second refrigerant lines 52 run to an air conditioning condenser 46 mounted outside the housing 16 and then to the connection point. Evaporator lines 36 connected to the lines 24 and 52 run from the connection point on the housing 16 to an evaporator 28 inside the tractor 10 to provide cooling. Other elements of the air conditioning system are similar to well know automotive air conditioning.

The auxiliary engine 18 is preferably water cooled, and heat from the coolant may be used to provide heat to the tractor 10 interior. The evaporator 28 preferable includes heater coils mounted adjacent to air conditioning coils and the heater water lines 42 preferably connect the auxiliary engine to the heater coils for heating the tractor 10. The heater coils may alternative be in a housing separate from the evaporator 28.

A radiator 48 and fan 54 are mounted outside the housing 16 and the air conditioning condenser is preferably mounted against the radiator 48 to share an air flow generated by the fan 54. Radiator hoses 44 connected the auxiliary engine 18 to the radiator 48 to cool the auxiliary engine.

The control unit 50 controls the starting and running of the APU 14 and specifically controls starting and stopping the auxiliary engine 18. The control unit 50 also controls a clutch 20a on the compressor 20 and a clutch 30a or electrical engagement of the alternator 30 to engage and disengage the compressor 20 and the alternator 30 as desired, for example, by the methods below. A humidity sensor 56 residing in the tractor 10 provides a humidity measurement through a cable 58 to the control unit 50, which measurement may be used along with a temperature measurement to control a dehumidifier function.

The auxiliary engine 18 may be a diesel, gasoline, LPG, propane, or alternative fuel engine, but is preferably a diesel engine. Examples of suitable auxiliary engines include a model 3ca1-azop engine manufactured by Isuzu Diesel Engines in Isuzu, Japan, or a model 2TNV70 manufactured by Yanmar in Buffalo Grove, Ill. An example of a suitable DC alternator is a Model DR140 made by Quick Start in Belmont, Mich. An example of a suitable inverter is a Trip Lite model RV2012UL available from Power Up Technologies in Glendale, Ariz. An example of a suitable air conditioning compressor is a Flex 7 compressor made by Sandon in Wylie, Tex.

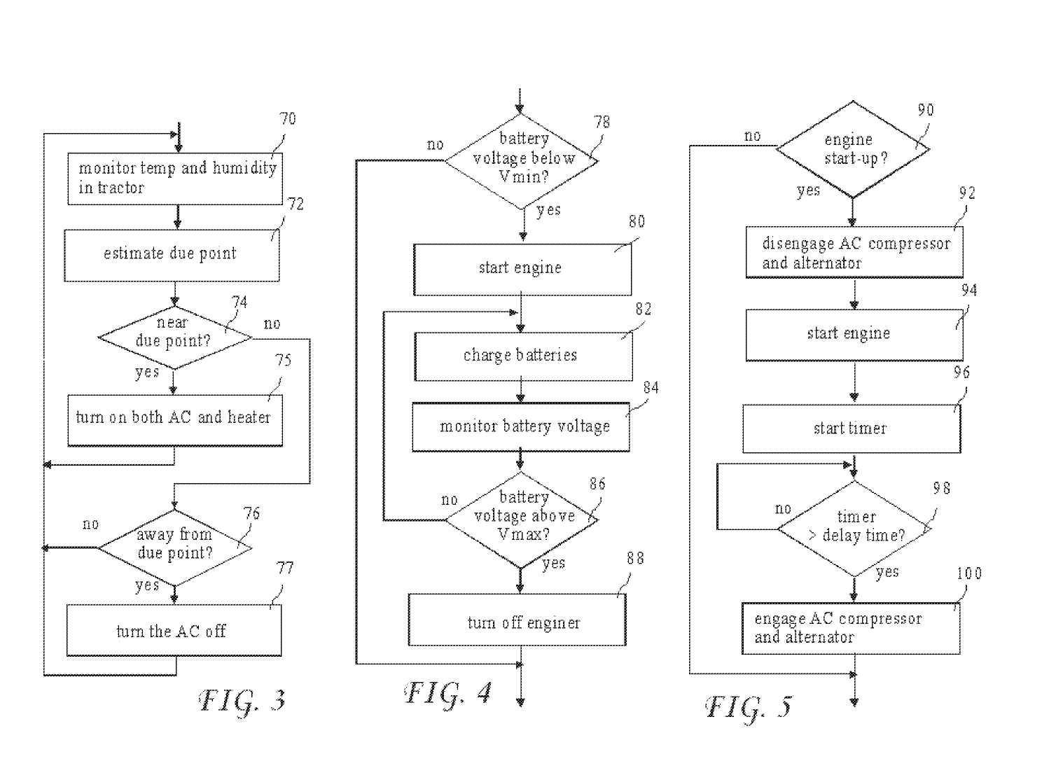

A first method according to the present invention for controlling humidity (the dehumidifier function) in the tractor 10 is described in FIG. 3. The first method includes monitoring the temperature and humidity in the tractor 10 at step 70, estimating proximity to a due point based on the temperature and humidity at step 72, comparing the proximity to the due point to a lower first threshold at step 74, and if the proximity is close, turning on both heating and air conditioning at the same time to reduce humidity in the tractor at step 75, comparing the proximity to the due point to a higher second threshold at step 76, and if the proximity is far, turning the air conditioning off at step 77.

A second method according to the present invention for automatic operation of the APU is described in FIG. 4. The battery charge level (preferably battery voltage) is measured at step 78. If the batter charge is below a threshold, the control unit 50 starts the auxiliary engine 18 to recharge the battery at step 80 and the batteries are charged at step 82. Monitoring the battery charge is continued at step 84, and when the battery charge exceeds a threshold at step 86, the control unit 50 turns the auxiliary engine 18 off at step 88.

A third method according to the present invention for controlling APU auxiliary engine start-up is described in FIG. 5. If the compressor 20 and alternator 30 are engaged at auxiliary engine start-up, the auxiliary engine is likely to fail to start due to the load. If auxiliary engine start-up is detected at step 90, the compressor 20 and alternator 30 are disengaged from the auxiliary engine 18 at step 92, the engine is started at step 94, and a timer is started at step 96. If the timer reached a delay threshold at step 98, the compressor and alternator are engaged (the compressor may not always be engaged) at step 100 for normal operation. Alternatively, engine RPM, or some other operating parameter, may be tested instead of using the time delay.

While the invention herein disclosed has been described by means of specific embodiments and applications thereof, numerous modifications and variations could be made thereto by those skilled in the art without departing from the scope of the invention set forth in the claims.

I claim:

1. An Auxiliary Power Unit (APU) comprising:
an auxiliary engine;
a Direct Current (DC) alternator run by the auxiliary engine;
electrical connections between the DC alternator and a main battery for recharging the main battery; and
an inverter receiving DC power from the DC alternator while the auxiliary motor is running and from the main battery when the auxiliary engine is not running, and converting the DC power to Alternating Current (AC) power.

2. The APU of claim 1, further including an air conditioning compressor run off the auxiliary engine.

3. The APU of claim 2, further including a control unit and logic which disengages the air conditioning compressor during start-up of the auxiliary engine.

4. The APU of claim 1, wherein the auxiliary engine is a variable speed auxiliary engine.

5. The APU of claim 4, wherein the auxiliary engine is a variable speed diesel auxiliary engine.

6. The APU of claim 4, wherein the auxiliary engine is liquid cooled and heat from the liquid may be used to heat the interior of the tractor.

7. The APU of claim 1, further including a control unit and logic which disengages the DC alternator during start-up of the auxiliary engine.

8. The APU of claim 1, further including a control unit and logic which monitors a battery charge level and starts the auxiliary engine when the charge level is low and stops the auxiliary engine when the battery is charged.

9. A truck comprising:
a main engine for providing power to drive the truck;
an Auxiliary Power Unit (APU) providing air conditioning, heating, and auxiliary power when the main engine is not running, the APU comprising:
an auxiliary engine;
an air conditioning compressor run by the auxiliary engine;
a Direct Current (DC) alternator run by the auxiliary engine and generating DC electrical power; and
an inverter receiving the DC electrical power from the alternator and converting the DC electrical power to Alternating Current (AC) power; and
an evaporator residing inside the truck and receiving refrigerant from the APU and heated coolant from the APU.

10. An Auxiliary Power Unit (APU) system comprising:
an APU providing air conditioning, heating, and auxiliary power, the APU comprising:
an APU housing;
a liquid cooled diesel auxiliary engine residing inside the APU housing;
an air conditioning compressor run by the auxiliary engine and residing inside the APU housing; and
a Direct Current (DC) alternator run by the auxiliary engine and generating DC electrical power and residing inside the APU housing;
a control unit for controlling the APU residing inside the APU housing;
electrical connections between the DC alternator and a main battery for recharging the battery;
a radiator for the auxiliary engine residing outside the APU housing
an air conditioning condenser connected to the air conditioning compressor and residing outside the APU housing;
a fan providing a flow of air through the radiator and the air conditioning condenser;
an inverter receiving the DC electrical power from the DC alternator and from the main battery, and converting the DC electrical power to Alternating Current (AC) power; and
an evaporator residing outside the APU housing and receiving refrigerant from the APU and heated liquid coolant from the APU.
